(19) United States
(12) Patent Application Publication
(10) Pub. No.: US 2023/0241487 A1
(43) Pub. Date: Aug. 3, 2023

(54) Baseball Catcher's Chest Protector

(71) Applicant: MIZUNO CORPORATION, Osaka (JP)

(72) Inventors: Kosuke MIYAKOSHI, Osaka (JP); Wataru TANAKA, Osaka (JP); Tetsuya SASAMORI, Osaka (JP); Yusuke YOSHIKAWA, Osaka (JP); Yuki TAKAYAMA, Osaka (JP)

(21) Appl. No.: 18/104,964

(22) Filed: Feb. 2, 2023

(30) Foreign Application Priority Data
Feb. 3, 2022 (JP) 2022-015676

(51) Int. Cl. A63B 71/12

(52) U.S. Cl. CPC A63B 71/12; A63B 2071/1208

(57) ABSTRACT

A baseball catcher's chest protector includes a base member, a cover member, and a cushioning member. The cover member is attached to the base member. The cushioning member is attached to the base member and is sandwiched between the base member and the cover member. The cushioning member includes a foundation and a plurality of protrusions. The plurality of protrusions protrude from the foundation. The foundation has a first surface and a second surface. The first surface faces the base member. The second surface is arranged opposite to the base member with respect to the first surface and faces the cover member. Each of the plurality of protrusions protrudes from the second surface toward the cover member and the plurality of protrusions are arranged with a space being interposed between the plurality of protrusions.

### CROSS REFERENCE TO RELATED APPLICATIONS

This non-provisional application is based on Japanese Patent Application No. 2022-015676 filed on Feb. 3, 2022 with the Japan Patent Office, the entire contents of which are hereby incorporated by reference.

### BACKGROUND OF THE INVENTION

### Field of the Invention

The present invention relates to a baseball catcher's chest protector.

### Description of the Background Art

In baseball or softball, a catcher may stop a ball thrown by a pitcher and bounced once, by hitting the ball against a chest protector. For example, Japanese Patent Laying-Open No. 2009-273678 discloses a baseball catcher's chest protector to effectively stop movement of a ball thrown by a pitcher and bounced once.

In the baseball catcher's chest protector described in the above publication, energy of the ball after hitting the chest protector cannot be sufficiently reduced. Therefore, the ball cannot be sufficiently stopped.

### SUMMARY OF THE INVENTION

The present invention has been made in view of the above-described problem and has an object to provide a baseball catcher's chest protector that can sufficiently reduce energy of a ball after hitting.

A baseball catcher's chest protector of the present invention includes a base member, a cover member, and a cushioning member. The cover member is attached to the base member. The cushioning member is attached to the base member and is sandwiched between the base member and the cover member. The cushioning member includes a foundation and a plurality of protrusions. The plurality of protrusions protrude from the foundation. The foundation has a first surface and a second surface. The first surface faces the base member. The second surface is arranged opposite to the base member with respect to the first surface and faces the cover member. Each of the plurality of protrusions protrudes from the second surface toward the cover member, and the plurality of protrusions are arranged with a space between the plurality of protrusions.

According to the baseball catcher's chest protector of the present invention, energy of a ball after hitting the chest protector can be sufficiently reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view schematically showing a configuration of a baseball catcher's chest protector according to an embodiment.

FIG. 2 is a rear view schematically showing the configuration of the baseball catcher's chest protector according to the embodiment.

FIG. 3 is a front view schematically showing an arrangement of a cushioning member of the baseball catcher's chest protector according to the embodiment.

FIG. 4 is a cross sectional view taken along a line IV-IV in FIG. 1.

FIG. 5 is a perspective view showing a portion V in FIG. 3.

FIG. 6 is a perspective view schematically showing a configuration of a modification 1 of the cushioning member of the baseball catcher's chest protector according to the embodiment.

FIG. 7 is a perspective view schematically showing a configuration of a modification 2 of the cushioning member of the baseball catcher's chest protector according to the embodiment.

FIG. 8 is a perspective view schematically showing a configuration of a modification 3 of the cushioning member of the baseball catcher's chest protector according to the embodiment.

FIG. 9 is a perspective view schematically showing a configuration of a modification 4 of the cushioning member of the baseball catcher's chest protector according to the embodiment.

FIG. 10 is a perspective view schematically showing a configuration of a modification 5 of the cushioning member of the baseball catcher's chest protector according to the embodiment.

FIG. 11 is a perspective view schematically showing a configuration of a modification 6 of the cushioning member of the baseball catcher's chest protector according to the embodiment.

FIG. 12 is a cross sectional view schematically showing an arrangement of the cushioning member of the baseball catcher's chest protector according to the embodiment.

FIG. 13 is a schematic diagram for illustrating a measurement method in each of an Example 1 and a Comparative Example.

FIG. 14 is a schematic diagram for illustrating a method of calculating a spin of a ball after hitting the chest protector.

FIG. 15 is a graph showing measurement results of Example 1 and the Comparative Example.

FIG. 16 is a graph showing measurement results of Examples 2 to 6.

### DESCRIPTION OF THE PREFERRED EMBODIMENTS

Hereinafter, embodiments of the present invention will be described with reference to figures. It should be noted that in the figures described below, unless otherwise stated particularly, the same or corresponding portions are denoted by the same reference characters and will not be described repeatedly.

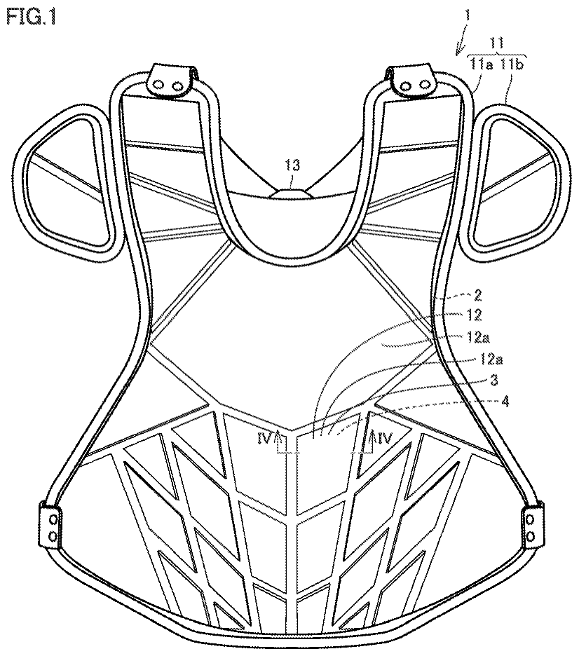

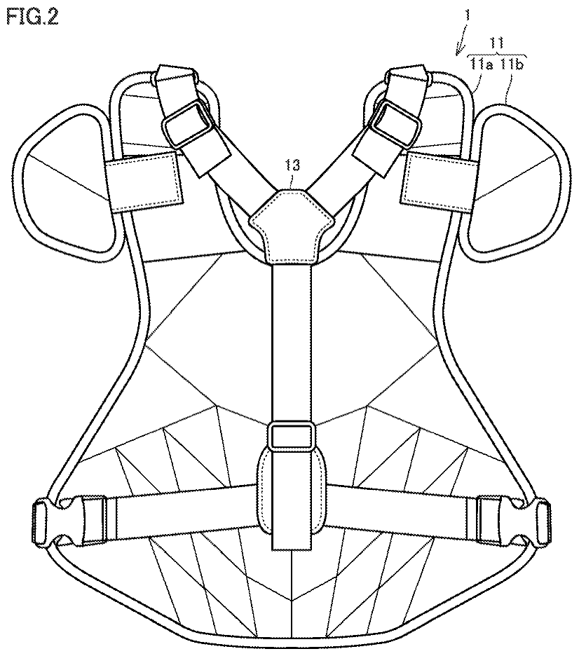

Referring to FIGS. 1 to 3, a configuration of a baseball catcher's chest protector 1 according to an embodiment will be described. As shown in FIGS. 1 and 2, baseball catcher's chest protector 1 according to the embodiment includes a main body portion 11, an elevation 12, and a belt portion 13. Main body portion 11 includes a chest/belly portion 11a and a shoulder portion 11b. Chest/belly portion 11a is configured to cover the chest and belly of the catcher. Shoulder portion 11b is configured to cover the shoulder of the catcher. Elevation 12 is configured to be elevated from main body portion 11 toward the front side of baseball catcher's chest protector 1. Elevation 12 is separated into a plurality of regions. That is, elevation 12 includes a plurality of elevation portions 12a. Belt portion 13 is attached to the upper end portion and left and right end portions of chest/belly portion 11a.

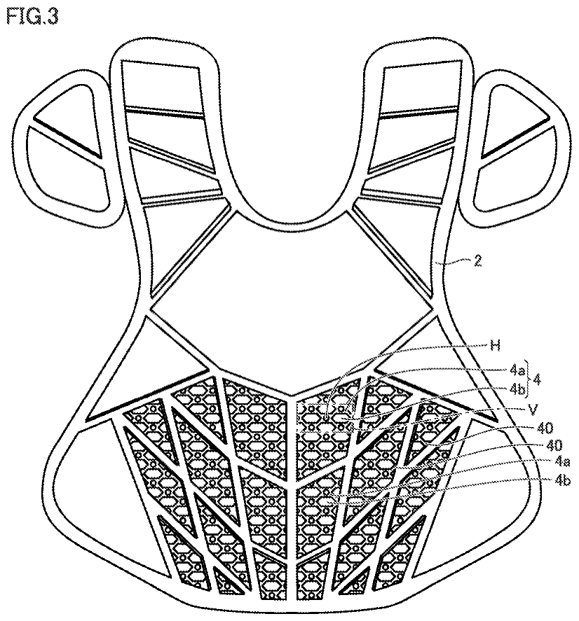

As shown in FIGS. 1 and 3, baseball catcher's chest protector 1 includes a base member 2, a cover member 3, and a cushioning member 4. Base member 2 is a portion serving as a base of main body portion 11. Base member 2 forms an outer shape of main body portion 11 when viewed in a plan view. Base member 2 has a larger thickness than that of cover member 3. Cover member 3 is attached to base member 2. Cover member 3 is configured to cover base member 2. Cover member 3 is configured to cover cushioning member 4. Cushioning member 4 is attached to base member 2. Cushioning member 4 is sandwiched between base member 2 and cover member 3. Cushioning member 4 is arranged between base member 2 and cover member 3. Cushioning member 4 is configured to absorb shock. Cushioning member 4 is deformable. A material of cushioning member 4 is, for example, EVA (Ethylene-Vinyl Acetate).

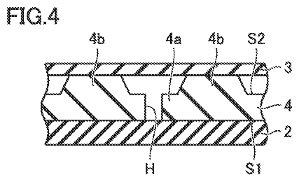

Referring to FIGS. 3 and 4, cushioning member 4 includes a foundation 4a and a plurality of protrusions 4b. Foundation 4a has a first surface S1 and a second surface S2. First surface S1 is arranged on the rear surface side of foundation 4a. First surface Si faces base member 2. First surface Si is formed to be flat. Second surface S2 is arranged on the front side of foundation 4a. Second surface S2 is arranged opposite to base member 2 with respect to first surface S1. Second surface S2 faces cover member 3. Second surface S2 is formed to be flat.

Foundation 4a is provided with a plurality of through holes H. Each of the plurality of through holes H extends through first surface S1 and second surface S2. The plurality of through holes H are arranged between the plurality of protrusions 4b when viewed from the front side of foundation 4a.

The plurality of protrusions 4b protrude from foundation 4a toward the front side. Each of the plurality of protrusions 4b protrudes from second surface S2 toward cover member 3. The plurality of protrusions 4b are arranged with a space being interposed therebetween.

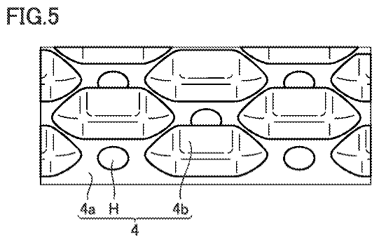

Referring to FIGS. 3 and 5, the plurality of protrusions 4b are formed to have the same shape. Each of the plurality of protrusions 4b is formed to have a horizontally elongated hexagonal shape when viewed from the front side of foundation 4a. Each of the plurality of protrusions 4b is formed to have a height that is decreased from its quadrangular portion at the center toward vertexes of its triangular portions at both ends. The plurality of protrusions 4b are arranged at equal intervals in an upward/downward direction (vertical direction). In the upward/downward direction (vertical direction), adjacent protrusions 4b of the plurality of protrusions 4b are arranged to be separated from each other by a size of a short side of the quadrangular portion. The plurality of protrusions 4b are arranged at equal intervals in a leftward/rightward direction (lateral direction). In the leftward/rightward direction (lateral direction), adjacent protrusions 4b of the plurality of protrusions 4b are arranged to be separated from each other by a size of a long side of the quadrangular portion.

Referring to FIGS. 1 and 3, cushioning member 4 includes a plurality of members 40. The plurality of members 40 are arranged with a space being interposed therebetween. Each of the plurality of members 40 has the plurality of protrusions 4b. The plurality of members 40 are arranged at the plurality of elevation portions 12a.

In the present embodiment, cushioning member 4 including foundation 4a and the plurality of protrusions 4b is arranged only at elevation 12 located at the belly portion of chest/belly portion 11a. In other words, cushioning member 4 including foundation 4a and the plurality of protrusions 4b is not arranged at the chest portion of chest/belly portion 11a and elevation 12 of shoulder 11b. It should be noted that cushioning member 4 including foundation 4a and the plurality of protrusions 4b may be arranged at the chest portion of chest/belly portion 11a and elevation 12 of shoulder portion 11b.

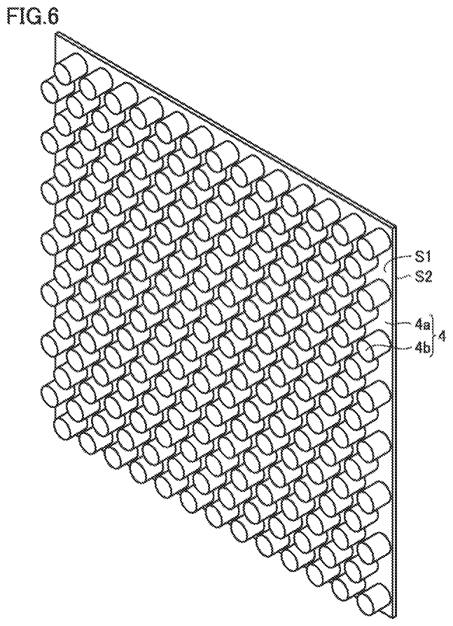

Next, referring to FIGS. 6 to 11, modifications of cushioning member 4 of baseball catcher's chest protector 1 according to the embodiment will be described.

As shown in FIG. 6, in a modification 1 of cushioning member 4 of baseball catcher's chest protector 1 according to the embodiment, each of the plurality of protrusions 4b is formed to have a cylindrical shape. The plurality of protrusions 4b are arranged in a plurality of rows. In adjacent rows of the plurality of rows, the plurality of protrusions 4b are arranged in a staggered manner. In other words, in the adjacent rows of the plurality of rows, the plurality of protrusions 4b are arranged to be displaced from one another. Each of the plurality of protrusions 4b has a diameter of, for example, 10 mm. Each of the plurality of protrusions 4b has a height of, for example, 10 mm. A distance between respective centers of the plurality of protrusions 4b is, for example, 15 mm.

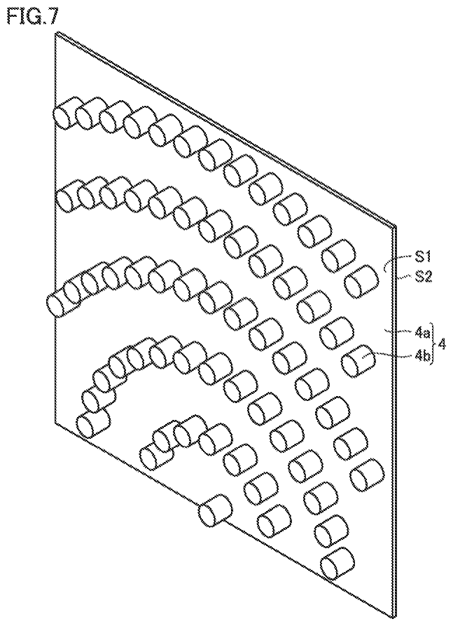

As shown in FIG. 7, in a modification 2 of cushioning member 4 of baseball catcher's chest protector 1 according to the embodiment, each of the plurality of protrusions 4b is formed to have a cylindrical shape. The plurality of protrusions 4b are arranged in a plurality of rows. Each of the plurality of rows is arranged in the form of a fan. The plurality of rows are arranged with a space being interposed therebetween. Each of the plurality of protrusions 4b has a diameter of, for example, 10 mm. Each of the plurality of protrusions 4b has a height of, for example, 10 mm. A distance between respective centers of the plurality of protrusions 4b is, for example, 15 mm.

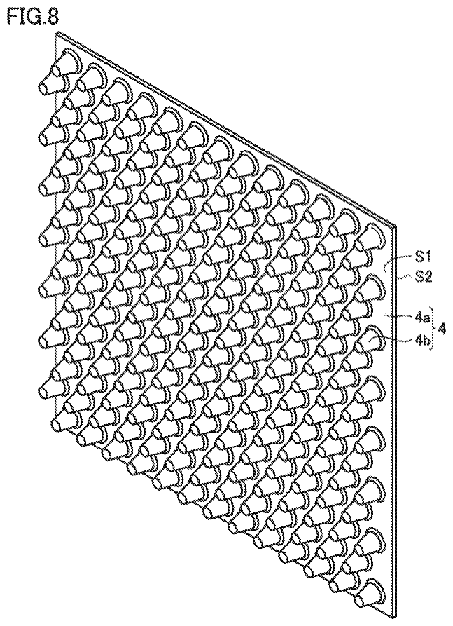

As shown in FIG. 8, in a modification 3 of cushioning member 4 of baseball catcher's chest protector 1 according to the embodiment, each of the plurality of protrusions 4b is formed to have a truncated-cone shape. The plurality of protrusions 4b are arranged in a plurality of rows. In adjacent rows of the plurality of rows, the plurality of protrusions 4b are arranged in a staggered manner. In other words, in the adjacent rows of the plurality of rows, the plurality of protrusions 4b are arranged to be displaced from one another. An upper surface of each of the plurality of protrusions 4b has a diameter of, for example, 5 mm. A bottom surface of each of the plurality of protrusions 4b has a diameter of, for example, 10 mm. Each of the plurality of protrusions 4b has a height of, for example, 10 mm. A distance between respective centers of the plurality of protrusions 4b is, for example, 15 mm. Each of the plurality of protrusions 4b is provided with a skirt in the form of a curved surface extending from its side surface located at a height of 2 mm from its bottom surface to a position located outward by 2 mm from an end portion of the bottom surface.

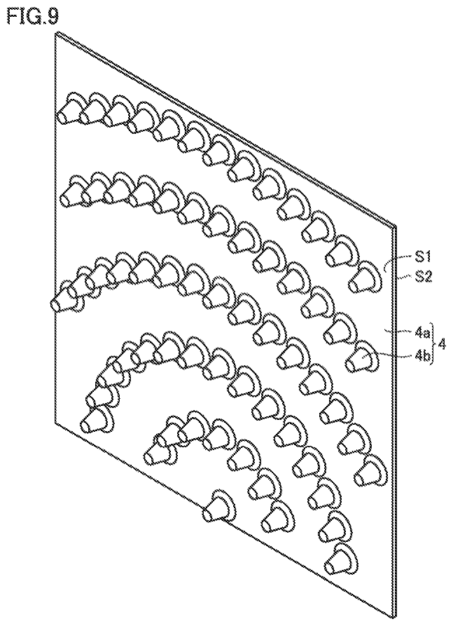

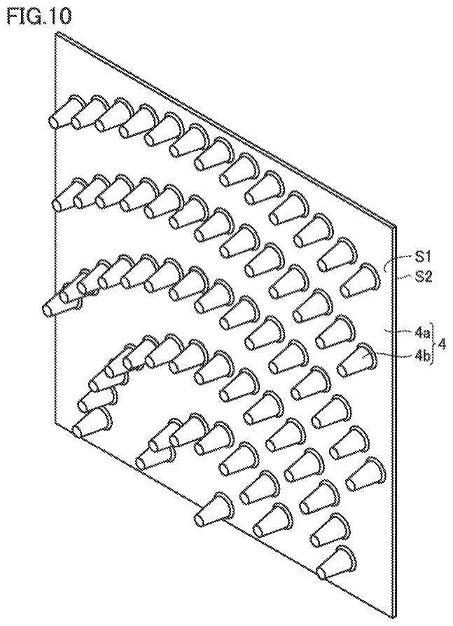

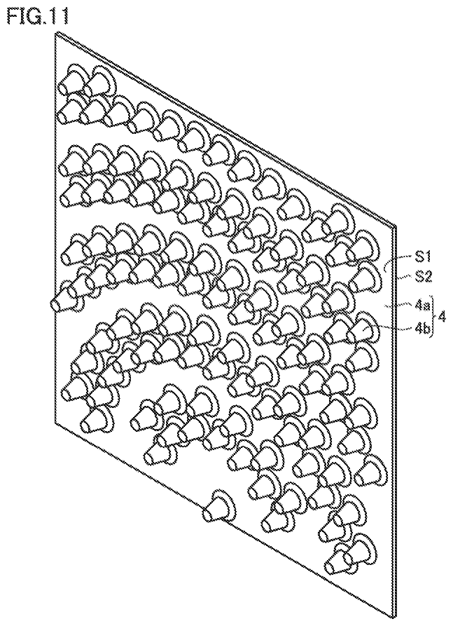

As shown in FIG. 9, in a modification 4 of cushioning member 4 of baseball catcher's chest protector 1 according to the embodiment, each of the plurality of protrusions 4b is formed to have a truncated-cone shape. The plurality of protrusions 4b are arranged in a plurality of rows. Each of the plurality of rows is arranged in the form of a fan. The plurality of rows are arranged with a space being interposed therebetween. An upper surface of each of the plurality of protrusions 4b has a diameter of, for example, 5 mm. A bottom surface of each of the plurality of protrusions 4b has a diameter of, for example, 10 mm. Each of the plurality of protrusions 4b has a height of, for example, 10 mm. A distance between respective centers of the plurality of protrusions 4b is, for example, 15 mm. Each of the plurality of protrusions 4b is provided with a skirt in the form of a curved surface extending from its side surface located at a height of 2 mm from its bottom surface to a position located outward by 2 mm from an end portion of the bottom surface. As shown in FIG. 10, in a modification 5 of cushioning member 4 of baseball catcher's chest protector 1 according to the embodiment, each of the plurality of protrusions 4b has a height size larger than that in modification 4. Each of the plurality of protrusions 4b is formed to have a truncated-cone shape. The plurality of protrusions 4b are arranged in a plurality of rows. Each of the plurality of rows is arranged in the form of a fan. The plurality of rows are arranged with a space being interposed therebetween. An upper surface of each of the plurality of protrusions 4b has a diameter of, for example, 5 mm. A bottom surface of each of the plurality of protrusions 4b has a diameter of, for example, 10 mm. Each of the plurality of protrusions 4b has a height of, for example, 15 mm. A distance between respective centers of the plurality of protrusions 4b is, for example, 15 mm. Each of the plurality of protrusions 4b is provided with a skirt in the form of a curved surface extending from its side surface located at a height of 2 mm from its bottom surface to a position located outward by 2 mm from an end portion of the bottom surface. As shown in FIG. 11, in a modification 6 of cushioning member 4 of baseball catcher's chest protector 1 according to the embodiment, each of the plurality of protrusions 4b is formed to have a truncated-cone shape. The plurality of protrusions 4b are arranged in a plurality of rows. Each of the plurality of rows is arranged in the form of a fan. The plurality of rows are arranged with a space being interposed therebetween. The plurality of rows are arranged with a wide space being provided for each two rows of the plurality of rows. An upper surface of each of the plurality of protrusions 4b has a diameter of, for example, 5 mm. A bottom surface of each of the plurality of protrusions 4b has a diameter of, for example, 10 mm. Each of the plurality of protrusions 4b has a height of, for example, 10 mm. A distance between respective centers of the plurality of protrusions 4b is, for example, 15 mm. Each of the plurality of protrusions 4b is provided with a skirt in the form of a curved surface extending from its side surface located at a height of 2 mm from its bottom surface to a position located outward by 2 mm from an end portion of the bottom surface.

Further, each of the plurality of protrusions 4b may be formed to have an elliptic cylindrical shape or an elliptic truncated-cone shape.

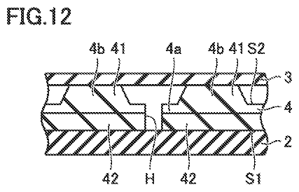

Referring to FIG. 12, cushioning member 4 may have two layers. Cushioning member 4 includes a first layer 41 and a second layer 42 stacked on the first layer. First layer 41 is arranged to face cover member 3. First layer 41 has the plurality of protrusions 4b. Second layer 42 is arranged to face base member 2. Second layer 42 has the same projected area as that of first layer 41. Second layer 42 has no protrusions. First layer 41 has a function of suppressing spin of a ball. Second layer 42 has low resilience. Further, second layer 42 is a member for improving a cushioning effect.

Next, functions and effects of baseball catcher's chest protector 1 according to the embodiment will be described.

Energy of a ball after hitting is calculated based on the following formula 1. Symbols in formula 1 are as follows. E represents a total energy amount (J). I represents a moment of inertia (kg·m²). ω represents an angular velocity (rad/s). M represents a mass (kg). v represents a speed (m/s). g represents an acceleration of gravity (m/s²). z represents a height (m).

E=(½)Iω²+(½)Mv²+Mgz (1)

Angular velocity ω of the ball and spin N of the ball are in a relation represented by the following formula 2:

N=ω×60/2π (2)

That is, angular velocity co of the ball and spin N of the ball are in a proportional relation. Therefore, when angular velocity ω of the ball is reduced, spin N of the ball is reduced. Further, when spill N of the ball is reduced, energy E of the ball is reduced.

According to baseball catcher's chest protector l according to the embodiment, each of the plurality of protrusions 4b protrudes from second surface S2 toward cover member 3, and the plurality of protrusions 4b are arranged with a space therebetween.

When there are no protrusions 4b of cushioning member 4, a real area of contact with the ball is small because there is actually an uncontacted portion even though the entire surface of cushioning member 4 is seemingly contacted by the ball. It should be noted that the real area of contact is a minute area of actual contact in the seeming contact area. On the other hand, in baseball catcher's chest protector 1 according to the embodiment, since the plurality of protrusions 4b are independent. many protrusions 4b can be contacted by a peripheral edge portion of the ball.

Further, a corner of protrusion 4b on the front side with respect to the spinning direction of the ball is contacted by the ball. This portion is high in pressure and therefore touches the ball, thus resulting in a high friction coefficient.

Therefore, the angular velocity and spin of the ball can be reduced. Thus, energy of the ball can be sufficiently reduced. Hence, the ball can be sufficiently stopped.

According to baseball catcher's chest protector 1 according to the embodiment, each of the plurality of protrusions 4b is formed to have a cylindrical shape, a truncated-cone shape, an elliptic cylindrical shape, or an elliptic truncated-cone shape. Therefore, the entire periphery of each of the plurality of protrusions 4b can be contacted by the ball. Thus, the energy of the ball can be sufficiently reduced at the entire periphery of each of the plurality of protrusions 4b.

According to baseball catcher's chest protector 1 according to the embodiment, each of the plurality of rows is arranged in the form of a fan and the plurality of rows are arranged with a space being interposed between the plurality of rows. Therefore, the ball after hitting the chest protector can be guided toward the center of the form of the fan.

According to baseball catcher's chest protector 1 according to the embodiment, the plurality of rows are arranged with a wide space being provided for each two rows of the plurality of rows. Therefore, the ball after hitting the chest protector can be guided toward the center of the form of the fan.

According to baseball catcher's chest protector 1 according to the embodiment, each of the plurality of members 40 has the plurality of protrusions 4b. Thus, since the plurality of members 40 are arranged at the plurality of elevation portions 12a, the plurality of protrusions 4b can be arranged at each of the plurality of elevation portions 12a.

According to baseball catcher's chest protector 1 according to the embodiment, cushioning member 4 includes first layer 41 and second layer 42 stacked on first layer 41 Therefore, different materials can be used for first layer 41 and second layer 42. Further, first layer 41 is arranged to face cover member 3, and has the plurality of protrusions 4b. Therefore, the angular velocity and spin of the ball can be reduced.

### EXAMPLES

Examples of the present invention will be described in comparison with a comparative example. Examples 1 to 6 are the examples of the present invention. A Comparative Example is the comparative example for the examples of the present invention.

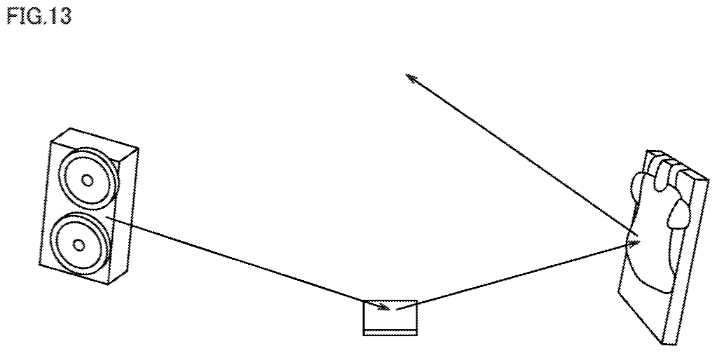

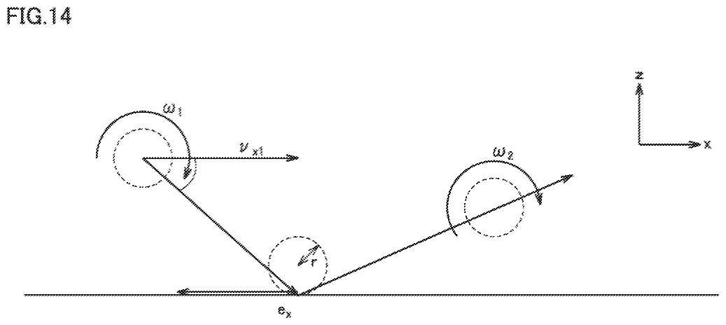

Referring to FIGS. 13 and 14, experiment for the Comparative Example and Example 1 will be described.

Conditions for a ball to hit the protector were set as follows: a ball speed of about 60 km/h; and a spin of about 4000 rpm. The ball was bounced once on a carpet and the ball bounded once hit the baseball catcher's chest protector. The spin of the ball after hitting the chest protector was measured. Verification was performed as to a degree of reduction of the spin of the ball after hitting from a spin (calculated value) of the ball when the baseball catcher's chest protector was not present.

The spin (calculated value) of the ball after hitting any plane was calculated based on the following formulas 3 and 4. Symbols in the formulas are as follows. ω₁ represents an angular velocity of the ball before being hit. ω₂ represents an angular velocity of the ball after hitting eₓ represents a coefficient of friction. vₓ₁ represents a speed of the ball in the x direction before being hit. r represents a radius of the ball. N represents a spin of the ball after hitting. It should be noted that the x direction is the horizontal direction, and the z direction is the vertical direction.

ω₂=((5(1+eₓ)vₓ₁+2(2−5eₓ(rω₁))/7r (3)

N=ω₂×60/2π (4)

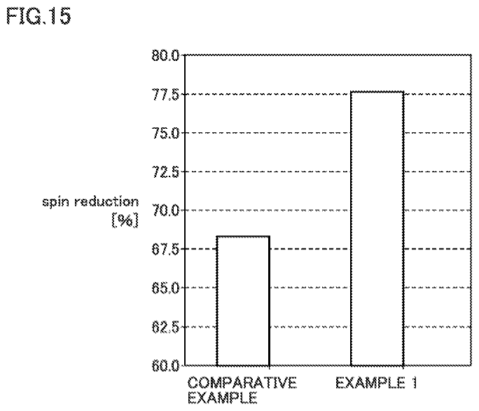

Referring to FIG. 15, the spins of the balls after hitting the chest protector in Example 1 and the Comparative Example were verified. FIG. 15 shows a spin reduction of the ball after hitting. The spin reduction of the ball after hitting the chest protector is a value obtained by dividing the measured value by the calculated value. The spin reduction of the ball after hitting the chest protector was calculated based on the following formula 5:

Spin reduction (%)=(1−(spin (measured value)/spin (calculated value)))×100 (5)

Example 1 has the structure of the above-described embodiment. The Comparative Example is a general baseball catcher's chest protector. In the Comparative Example, the plurality of protrusions of the cushioning member in Example 1 are not provided. In Example 1, the spin of the ball after hitting the chest protector was reduced as compared with that in the Comparative Example.

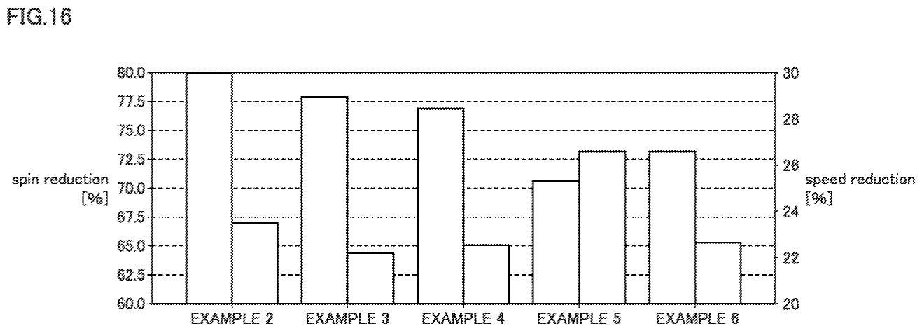

Referring to FIG. 16, the spin of the ball after hitting the chest protector in each of Examples 2 to 6 was verified. FIG. 16 shows the spin reduction of the ball after hitting and the speed reduction of the ball after hitting the chest protector. In each of Examples 2 to 6, only the cushioning member was used instead of the baseball catcher's chest protector in Example 1. The cushioning member is in the form of a square having a length of 20 cm and a width of 20 cm.

Example 2 has the structure of modification 1 of the embodiment. Example 3 has the structure of modification 2 of the embodiment. Example 4 has the structure of modification 6 of the embodiment. Example 5 has the structure of modification 5 of the embodiment. Example 6 has the structure of modification 4 of the embodiment. Among Examples 2 to 6, the spin reduction of the ball after hitting the chest protector in Example 2 was the largest. That is, in Example 2, the spin of the ball after hitting the chest protector was reduced the most, Among Examples 2 to 6, the speed reduction of the ball after hitting the chest protector in Example 5 was the largest. That is, in Example 5, the speed of the ball after hitting the chest protector was reduced the most. In Example 5, both the spin reduction of the ball after hitting the chest protector and the speed reduction of the ball after hitting the chest protector could be increased.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A baseball catcher's chest protector comprising:
a base member;
a cover member attached to the base member; and
a cushioning member attached to the base member and sandwiched between the base member and the cover member, wherein
the cushioning member includes a foundation and a plurality of protrusions protruding from the foundation,
the foundation has a first surface facing the base member, and a second surface arranged opposite to the base member with respect to the first surface and facing the cover member, and
each of the plurality of protrusions protrudes from the second surface toward the cover member, and the plurality of protrusions are arranged with a space being interposed between the plurality of protrusions.

2. The baseball catcher's chest protector according to claim 1, wherein each of the plurality of protrusions is formed to have a cylindrical shape, a truncated-cone shape, an elliptic cylindrical shape, or an elliptic truncated-cone shape.

3. The baseball catcher's chest protector according to claim 2, wherein
the plurality of protrusions are arranged in a plurality of rows, and
each of the plurality of rows is arranged in a form of a fan and the plurality of rows are arranged with a space being interposed between the plurality of rows.

4. The baseball catcher's chest protector according to claim 3, wherein the plurality of rows are arranged with a wide space being provided for each two rows of the plurality of rows.

5. The baseball catcher's chest protector according to claim 1, wherein
the cushioning member includes a plurality of members arranged with a space being interposed between the plurality of members, and
each of the plurality of members has the plurality of protrusions.

6. The baseball catcher's chest protector according to claim 1, wherein
the cushioning member includes a first layer and a second layer stacked on the first layer,
the first layer is arranged to face the cover member and has the plurality of protrusions, and
the second layer is arranged to face the base member.
